(19) United States
(12) Patent Application Publication
(10) Pub. No.: US 2002/0130870 A1
(43) Pub. Date: Sep. 19, 2002

(54) Information processing system, integrated information processing system, method for calculating execution load, and computer program

(76) Inventor: Hitoshi Ebihara, Kanagawa (JP)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/085,587

(22) Filed: Feb. 27, 2002

(30) Foreign Application Priority Data
Feb. 27, 2001 (JP) P2001-53208
Jan. 31, 2002 (JP) P2002-24692

(51) Int. Cl. G06T 11/20

(52) U.S. Cl. 345/440

(57) ABSTRACT

A graphics processing system includes a graphics processor for carrying out image processing, a control processor for use in producing a draw ready signal to enable the image processing, and a time counter for use in determining a process time for the image processing. The graphics processor begins execution of the image processing in response to the reception of the draw ready signal and produces a draw complete signal upon completion of the image processing. The draw complete signal represents the completion of the image processing. The time counter begins determination of the execution load on the processor in response to the reception of the draw ready signal and terminates the determination in response to the reception of the draw complete signal. This makes it possible to determine the process time from the beginning to the end of the image processing.

### CROSS-REFERENCE TO RELATED APPLICATIONS

The present application claims priority from Japanese Application Nos. 2001-53208 filed Feb. 27, 2001 and 2002-24692 filed Jan. 31, 2002, the disclosures of which are hereby incorporated by reference herein.

### BACKGROUND OF THE INVENTION

The present invention relates to a method and a system for a real-time presentation to an operator of execution loads on image processing in, for example, a graphics processor.

With the advancement of processing systems such as computers, the environment has been improved where more sophisticated information processing than before is being performed using such processing systems. Two or more processing systems cooperate with each other to achieve a single processing. For example, a large-scale video display may be produced by a number of image processing systems cooperating with each other. However, the throughput or performance as a whole cannot fully be demonstrated even if the individual processing systems have a higher processing capability. In other words, what is required is to distribute the execution loads among all processing systems involved in the operation to balance the execution loads on all of the systems. The execution load is the load at the time of performing processing.

For example, a large-scale video display may be produced by a number of image processing systems that cooperate with each other. In such a case, the processing is controlled so that the images are produced at the same time from all of the processing systems. However, a processing system may be delayed or unable to complete its allocated task(s) in time before the refresh of a display device to produce the images when the system is over capacity. In such a case, the system may drop some frames to display the image in a timely manner. This is typically called “frame dropping”. The frame-dropping results in loss of image data and the video image will appear “jumpy” and incomplete. A solution for this problem is to extend the interval between the images displayed. However, this produces a rather unnatural motion. As apparent from the above, even a single processing system that is over capacity may cause rough video images.

With this in mind, contents are tuned so that the execution load can be balanced among two or more processing systems to avoid the above-mentioned problems in the creation stage of the contents to be processed.

Conventionally, tuning of the contents involves examination of an event or a phenomenon caused during an actual operation performed by the processing system. Based on the results of the examination, an operator makes an assumption about which processing system would suffer from overloading. The examination and the assumption completely rely on the operator, such as a person who creates the contents. The operator, however, cannot determine in a quantitative manner what execution load should be assigned to each processing system. For this reason, tuning of the contents is time consuming.

Accordingly, there is a demand for a method for determining the execution load on each processing system quantitatively. The execution load on the processing system can be correctly measured in a quantitative manner by means of counting the number of polygons and the number of pixels to be drawn when, for example, the processing system is an image processing system. However, it is necessary to provide the image processing system with an additional structure or mechanism to determine the number of polygons and the number of pixels, which is not practical.

A major object of the present invention is to provide a method and a system for the easy determination of the state of the execution loads in an information processing system.

### SUMMARY OF THE INVENTION

In order to solve the above-mentioned problems, the present invention provides an information processing system, an integrated information processing system including a plurality of the information processing systems, a method for calculating execution loads, and a computer program.

An information processing system according to the present invention includes a processor operable to carry out predetermined information processing; a signal processing unit operable to produce an execution enabling signal for causing the processor to carry out the predetermined information processing; and a load determination unit operable to determine an execution load associated with the predetermined information processing.

The processor is operable to begin execution of the predetermined information processing in response to receipt of the execution enabling signal and to produce an execution termination signal upon completion of the predetermined information processing. The execution termination signal represents the completion of the predetermined information processing. The load determination unit is operable to begin determination of the execution load in response to receipt of the execution enabling signal and to terminate the determination of the execution load in response to receipt of the execution termination signal.

Another information processing system according to the present invention includes a processor operable to execute information processing having two or more steps, the information processing being carried out one step after another in a successive manner; a signal producing unit operable to produce an execution enabling signal at a predetermined cycle for causing the processor to execute the information processing; and a load determination unit operable to determine an execution load associated with the information processing for each of the steps. The processor is operable to begin execution of the information processing for one step each time the processor receives the execution enabling signal. The processor is also operable to produce an execution termination signal upon completion of the information processing for the one step, the execution termination signal representing the completion of the information processing for the one step. The load determination unit is operable to begin determination of the execution load in response to receipt of the execution enabling signal and to terminate the determination in response to receipt of the execution termination signal.

The information processing system described above may further include a presentation unit operable to provide a real-time presentation of a measurement of the execution load determined by the load determination unit.

The load determination unit may clear a previous measurement of the execution load already determined in response to the receipt of the execution enabling signal and may begin determination of a new measurement. With this configuration, the load can be determined for each unit of processing or for each step.

Yet another information processing system according to the present invention includes a processor operable to carry out predetermined information processing; a signal producing unit operable to produce an execution enabling signal for causing the processor to carry out the predetermined information processing; and a load determination unit operable to determine an execution load associated with the predetermined information processing.

In this information processing system, the processor is operable to supply a first enable signal and a second enable signal selectively to the load determination unit in response to receipt of the execution enabling signal, the first enable signal enabling execution of the predetermined information processing and representing an active state of execution when the predetermined information processing is being carried out, and the second enable signal representing an inactive state of execution when the predetermined information processing is not being carried out. The load determination unit is operable to begin determination of the execution load when the load determination unit receives the first enable signal and to terminate the determination when the load determination unit receives the second enable signal.

In this information processing system, the load determination unit may be configured to produce a value representing the execution load when the first enable signal is changed to the second enable signal.

Alternatively, the load determination unit may be configured to reset a previous measurement of the execution load already determined and to begin the determination when the second enable signal is changed to the first enable signal. With this configuration, the load can be determined for each unit of processing.

In these information processing systems, the execution load can be determined during the execution of the information processing carried out by the processor. A user can be provided with information about the execution loads on the basis of the quantitative measurements. The user can also check quantitatively how much resource is left for the processor and whether there is any processor that is possibly overloaded.

In these information processing systems, when the processor operates in response to clock signals, the execution load can be determined with the load determination unit counting the number of the clock signals from a beginning to an end of the predetermined information processing.

The load determination unit may include a presentation unit operable to provide a presentation of a measurement of the execution load which varies in form in real time depending on the measurement of the execution load. The presentation unit is used to provide a user with a presentation of the execution load on the processor. The presentation unit may include a plurality of light-emitting components. In such a case, the presentation unit may vary the number of the light-emitting components which are lit depending on the measurement of the execution load. Alternatively, the presentation unit may include a light-emitting component capable of emitting light beams of different colors. The presentation unit may vary the color of the light beams depending on the measurement of the execution load.

An integrated information processing system of the present invention has a plurality of the information processing systems described above; and a presentation unit. The presentation unit is operable to provide to a user a real-time presentation of a measurement of the execution load in each of the information processing systems.

Such an integrated information processing system allows easy and fast tuning of the contents and/or programs such that the execution loads are balanced among all information processing systems.

In the integrated information processing system, the information processing systems may be housed in a housing, and the presentation unit may be arranged on the front surface of the housing in a corresponding relationship with the processor of each of the information processing systems. This allows quick determination of the execution loads on the processor in the information processing system.

A light-emitting component may be used as the presentation mechanism. The color or the number of the light-emitting components to be lit is varied to provide a presentation of the execution load with an aesthetic value.

A method according to the present invention for determining an execution load associated with predetermined information processing includes producing an execution enabling signal for carrying out the predetermined information processing; beginning the predetermined information processing in response to receipt of the execution enabling signal; beginning determination of the execution load in response to receipt of the execution enabling signal; producing an execution termination signal upon completion of the predetermined information processing, the execution termination signal representing the completion of the predetermined information processing; and terminating the determination of the execution load in response to receipt of the execution termination signal.

Another method according to the present invention determines an execution load associated with information processing having two or more steps, the information processing being carried out one step after another step in a successive manner, the method including producing an execution enabling signal at a predetermined cycle for causing the information processing to be carried out step by step; beginning execution of the information processing for one step each time the execution enabling signal is received; producing an execution termination signal upon completion of the information processing; beginning determination of the execution load each time the execution enabling signal is received; and terminating the determination in response to receipt of the execution termination signal.

A computer-readable recording medium of the present invention is recorded with a program for determining an execution load associated with predetermined information processing, the program including producing an execution enabling signal for carrying out the predetermined information processing; beginning the predetermined information processing in response to receipt of the execution enabling signal; beginning determination of the execution load in response to receipt of the execution enabling signal; producing an execution termination signal upon completion of the predetermined information processing, the execution termination signal representing the completion of the predetermined information processing; and terminating the determination of the execution load in response to receipt of the execution termination signal. Such program is typically installed in a computer during the configuration of the system.

### BRIEF DESCRIPTION OF THE DRAWINGS

The above and further objects, features and advantages of the present invention will become apparent upon consideration of the following detailed description of a specific embodiment thereof, particularly when taken in conjunction with the accompanying drawings in which:

FIG. 1 is a block diagram of an information processing system;

FIG. 2 is a view illustrating a reference table;

FIG. 3 is a timing diagram illustrating a flow of determining an execution load;

FIG. 4 is a timing diagram illustrating another flow of determining an execution load;

FIG. 5 is a block diagram of an integrated graphics processing system;

FIG. 6 is a block diagram of a graphics subsystem module (GSM);

FIG. 7A is a schematic perspective view of a housing in which an integrated graphics processing system is housed;

FIG. 7B is a view illustrating a indicator;

FIG. 8 is a flow chart illustrating a routine to determine an execution load on a graphics subsystem module (GSM); and

FIG. 9 is a flow chart illustrating a routine to determine an execution load on a graphics subsystem block (GSB).

### DETAILED DESCRIPTION

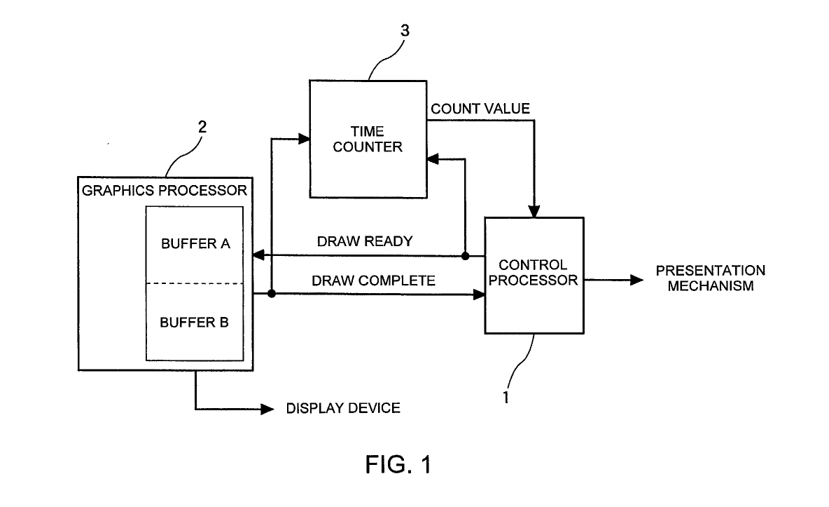

An embodiment of the present invention is described below for a case in which the present invention is applied to an information processing system for graphic images. As shown in FIG. 1, the information processing system comprises a control processor 1, a graphics processor 2, and a time counter 3. Each of the control processor 1, the graphics processor 2, and the time counter 3 may be stand alone devices. Alternatively, they may be incorporated in a single system or apparatus as parts, components, or devices of such system or apparatus. In either case, the control processor 1, the graphics processor 2, and the time counter 3 operate in accordance with the same clock signals.

The graphics processor 2 receives a stream of image data from an input section (not shown). The graphics processor 2 processes, frame by frame, the stream of the image data to produce a frame image. The graphics processor 2 carries out an operation to display the frame image on a display device.

More specifically, the graphics processor 2 comprises a frame memory into which the frame image being displayed is drawn. The frame memory has a so-called “double buffer” configuration. As the name indicates, there are two buffers. The double buffering allows for one image to be drawn while another is being displayed. More specifically, the graphics processor 2 carries out geometry processing (coordinate conversion) and rendering (drawing) to load a frame image into an off-screen buffer, such as buffer A, in response to a draw ready signal (process enable signal) from the control processor 1. When the frame image is complete in the off-screen buffer A, the graphics processor 2 supplies to the control processor 1 a draw complete signal (execution termination signal) indicating that the frame image is complete. Then, an operation is performed to change the off-screen buffer A to on-screen. The previous on-screen buffer, such as buffer B, becomes off-screen. The on-screen buffer A is used to refresh a display screen while the off-screen buffer B is used to load the next frame image. The buffers thus continue exchanging their roles.

The time counter 3 is provided with the draw ready signal transmitted from the control processor 1 to the graphics processor 2 and with the draw complete signal transmitted from the graphics processor 2 to the control processor 1. The time counter 3 measures the time interval between the reception of the draw ready signal and the reception of the draw complete signal.

The draw ready signal and the draw complete signal are each considered to be produced when it goes “LOW” or “HIGH” for one clock period. The measured time interval is supplied to the control processor 1 as an execution cycle for each frame image processed by the graphics processor 2. The execution cycle is provided to the control processor 1 as a count value. The time counter 3 may be a clock counter that resets a time count value and begins counting in response to the draw ready signal and terminates the counting in response to the draw complete signal. While the time counter 3 is illustrated as an independent component in FIG. 1, it may be incorporated in the control processor 1 or in the graphics processor 2.

In order to ensure that the frame images are alternately drawn in the frame memories (double buffers), the control processor 1 supplies the draw ready signal to the graphics processor 2. The draw ready signal may be, for example, a synchronous signal (V-SYNC).

The control processor 1 calculates an execution time in a given frame relative to the maximum time interval available for the processing of a predetermined one frame, that is, a ratio of the time count value received from the time counter 3. The ratio is calculated as a “usage rate”. The control processor 1 performs control operations to exhibit, as a measurement of the execution, the usage rate to a user through a presentation mechanism. The usage rate can be obtained by means of dividing the time count value by an output interval of the draw ready signals.

The presentation mechanism in this event may be a light-emitting component, such as a display device or light-emitting diode (LED), or a speaker. The control processor 1 indicates the state of the execution load in a real-time manner by means of, for example, providing different display images on the display device, changing the color or luminance of the light-emitting component, lighting a predetermined number of a plurality of light-emitting components, or altering the volume of the sound from the speaker, depending on the state of the execution load.

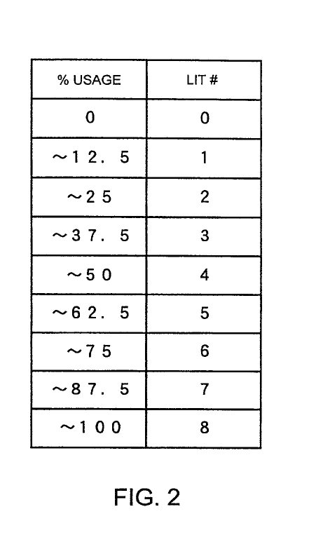

For the presentation purpose, the control processor 1 has a reference table as shown in FIG. 2. The illustrated reference table is for indicating the execution load with eight light-emitting components. The reference table provides a one-to-one correspondence between the usage rate and the number of the light-emitting components to be lit. For example, no light-emitting component is lit (lighting number=0) when the graphics processor 2 is not performing image processing (usage rate of 0%). Four light-emitting components are lit for a usage rate of 45%.

The reference table may be varied widely depending on the type of the presentation mechanism used. When the presentation mechanism is a display device, the usage rate is associated with modes of display (e.g., motion of a video image, display pattern, or color). The usage rate is associated with different levels of volume or the tone of the sound when the presentation mechanism is a speaker. A similar rule applies to any other presentation mechanisms.

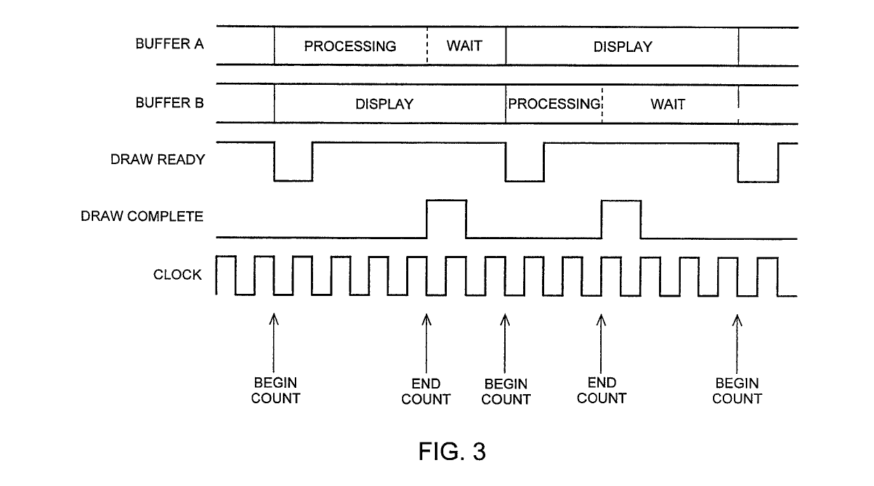

Referring to FIG. 3, an operation to determine the state of the execution load on the graphics processor 2 in the information processing system is described. It is assumed that the buffer A is used to refresh the display device and the buffer B is used to assemble the next frame image.

In response to the draw ready signal supplied from the control processor 1, the time counter 3 resets the time count value and begins measurement of a processing time for each frame. The graphics processor 2 changes the buffers in response to the reception of the draw ready signal. The graphics processor 2 provides the image in the buffer B on the display device and generates a frame image through image processing such as geometry processing. The graphics processor 2 draws the resulting frame image into the buffer A. After completion of loading of the frame image into the buffer A, the graphics processor 2 supplies the draw complete signal to the control processor 1. As shown in FIG. 3, the draw complete signal goes “HIGH” for one clock period to indicate that the signal is produced from the graphics processor 2. The time counter 3 terminates the measurement of the time when it determines the output of the draw complete signal. The time count value thus obtained indicates the time interval during which the graphics processor 2 performs the image processing, that is, the state of the execution load. The control processor 1 uses the reference table as shown in FIG. 2 to present the time count value to a user through the presentation mechanism used.

The above-mentioned operation is performed repeatedly for each frame to provide a real-time presentation of the latest execution load on the graphics processor 2 while showing an image on the display device. The indication of the execution load permits the user to keep track of how the image processing is being performed while he or she looks at the images on the display device, providing the user with information about the state of image processing. With that information, the user can create contents to fully exhibit the functionality of the graphics processor 2 and increase the performance of the graphics processor 2. The user can also tune his or her image processing program easily. The present invention offers significant benefits and excellent support for creating graphics-related contents or an image processing program expected to put a large load on a computer, such as 3D image processing.

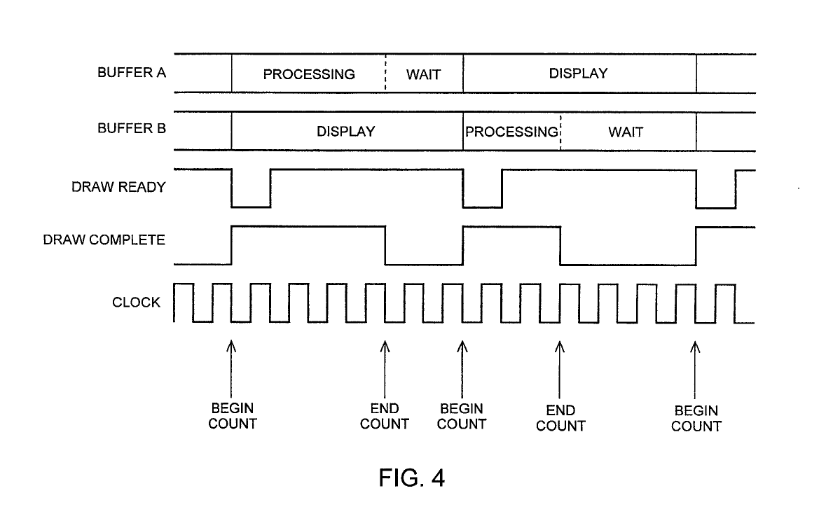

In the above-mentioned embodiment, the draw ready signal and the draw complete signal are used to indicate the start and end timings of the time measurement. However, only the draw complete signal may be used for this same purpose. More specifically, the draw complete signal may be in a “HIGH” state (first enable signal) for the time period when the image processing is being performed and may be in a “LOW” state (second enable signal) for the time period when no image processing is being performed, as shown in FIG. 4. The time counter 3 uses the draw complete signal as the enable signal to allow the measurement of the time when the draw complete signal is in the “HIGH” state. The draw complete signal is in the “HIGH” state during operation and goes to “LOW” at the time of completion of the operation. The time counter 3 is enabled for the measurement of the time only during the operation of the graphics processor 2.

In this case, the time count value is reset in response to the reception of the draw ready signal by the time counter 3. With the draw complete signal “HIGH”, the time counter 3 resets the time count value and begins the measurement of the time. With the draw complete signal “LOW”, the time counter 3 terminates the measurement and supplies the time count value to the control processor 1.

In the above-mentioned embodiment, all features of the information processing system 1 are implemented with the control processor 1, the graphics processor 2 and the time counter 3. However, the features equivalent to all or some of these features may be implemented as a combination of a computer program according to the present invention and a general-purpose computer with an image processing capability. More specifically, a functional block corresponding to the control processor 1, the graphics processor 2 and the time counter 3 may be achieved through cooperation between a control program, such as an operating system that runs on a computer, and the above-mentioned computer program stored in a computer-accessible data storage, such as a disk device or a semiconductor memory. The computer in question then serves as the information processing system according to the present invention. It is noted that the term “access to a data storage” as used herein includes both reading and writing of data to and from the data storage.

Next, a specific example of the information processing system according to the present invention is described. The present invention is applied to an integrated graphics processing system comprising a plurality of the above-mentioned information processing systems that serve as a graphics processor in this example. The integrated graphics processing system uses a plurality of graphics processors that cooperate with each other to support large-sized screen images, high quality images and full-dimensional images that are difficult to produce using a single graphics processor.

<Configuration>

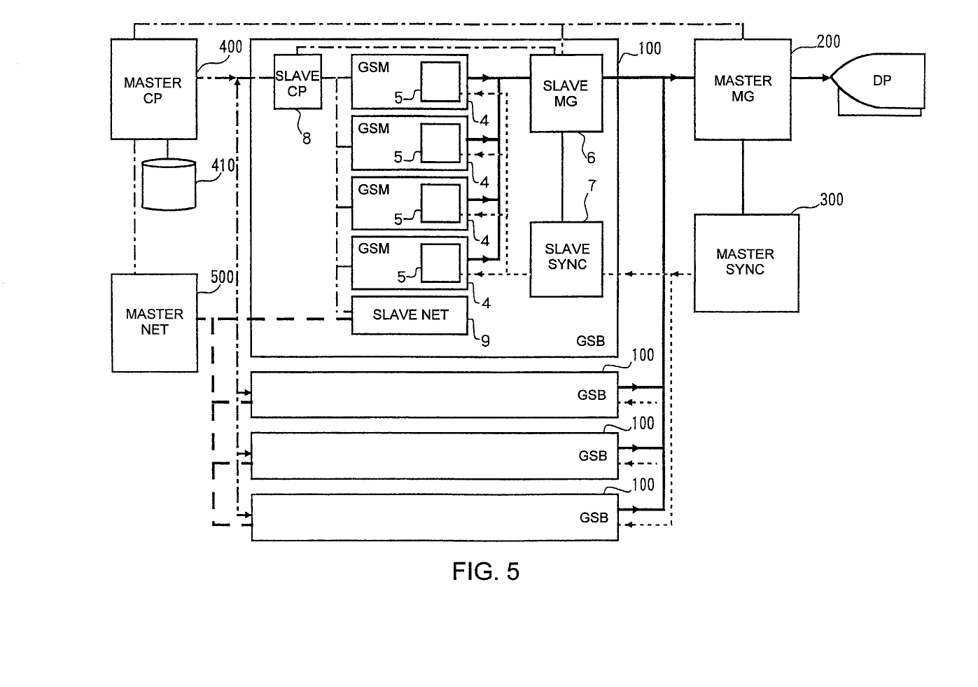

FIG. 5 shows an internal configuration of an integrated graphics processing system according to this example. The integrated graphics processing system comprises four graphics subsystem blocks (GSBs) 100 corresponding to the graphics processors, a merging unit (hereinafter, referred to as a “master MG”) 200, a synchronous circuit (hereinafter, referred to as a “master SYNC”) 300, a control processor (hereinafter, referred to as a “master CP”) 400, and a network control circuit (hereinafter, referred to as a “master NET”) 500. The master MG 200 is located at a subsequent stage of the GSBs 100 to merge outputs of the GSBs 100. The master SYNC 300 is connected to the GSBs 100 and the master MG 200. The master SYNC 300 supplies a synchronous signal (V-SYNC) and the draw ready signal (DrawNext) to the GSBs 100 and supplies the draw complete signal from the GSBs 100 to the master MG 200. The master CP 400 controls the entire integrated graphics processing system in an integrated manner. The master NET 500 is used to achieve cooperation of all GSBs 100.

An output port of the master MG 200 is connected to a display device DP on which results of image processing performed by the integrated graphics processing system are provided in an integrated manner. The master MG 200 controls in cooperation with the master CP 400 the timing at which data are transmitted from the master SYNC 300 to each GSB 100 and the timing at which data are transmitted from each GSB 100 to the master MG 200. The master CP 400 is connected to the master MG 200, an external storage 410 and the master NET 500.

<GSB>

The GSB 100 comprises four graphics subsystem modules (GSMs) 4, a merger (hereinafter, referred to as a “slave MG”) 6, a synchronous circuit (hereinafter, referred to as a “slave SYNC”) 7, a control processor (hereinafter, referred to as a “slave CP”) 8, and a network control circuit (hereinafter, referred to as a “slave NET”) 9. The GSM 4 produces a frame image corresponding to the image data received by the local GSM 4. The slave MG 6 receives the frame images from the GSMs 4 and merges them into a single merged frame image. The slave MG 6 supplies the merged frame image to a subsequent stage. The slave SYNC 7 supplies the V-SYNC and draw ready signals to each GSM 4 and transmits the draw complete signals received from the GSMs 4 to the master SYNC 300. The slave CP 8 controls the operations of the GSMs 4. The slave NET 9 is used to achieve cooperation of all GSMs 4 in the same GSB 100 and other GSB(s) 100. It is noted that the slave NET 9 may be eliminated when the master NET 500 has a function similar to that of the slave NET 9.

Each GSM 4 comprises a synchronous circuit (hereinafter, referred to as a “SYNC-GSM”) 5. The V-SYNC and draw ready signals are supplied from the SYNC-GSM 5 to an internal circuit. The slave MG 6 and the master MG 200 each comprises a register where frame images to be produced are held temporarily. The slave CP 8 controls the operations of the entire GSB 100. The slave CP 8 comprises a demultiplexer (not shown) for distributing the received data as four data segments. The slave CP 8 distributes a stream of image data associated with a video image to be produced among four GSMs 4. The distribution may be performed in various ways depending on the type of the contents used in the present system. For example, a final image to be produced on the display device may be divided into four sections. Alternatively, layers forming the final image may be separated as four streams of image data. The image data for four frames may first be merged and divided into four different sections.

The slave NET 9 is a circuit for use in exchanging a whole or a part of the streams of image data among the GSBs 100. The passing of the streams of the image data is mainly for the purpose of balancing the processing load among the GSBs 100 in processing images. The merging operation performed by the slave MG 6 is in synchronism with the absolute time axis that controls the operations of the entire GSBs 100. In other words, a plurality of frame images received in synchronization with the absolute time axis are merged into a single merged frame image.

Each GSM 4 is supplied with the streams of image data (from the master CP 400 via the slave CP 8) and the V-SYNC and draw ready signals (from the master SYNC 300 via the slave SYNC 7). In response to the draw ready signal, the GSM 4 begins image processing for the current stream of the image data. The SYNC-GSM 5, the slave SYNC 7, and the master SYNC 300 each comprises a data register and a plurality of counters. Each counter has a register for holding a counted value. When a counted value reaches a predetermined limit, an interrupt request is generated. A first counter is provided for synchronizing the operations of the GSMs 4. The first counter is incremented on a falling edge of the received synchronous signal (“V-SYNC”). A second counter is an up-counter for the measurement of the time intervals of the V-SYNCs with high accuracy. The second counter is reset to zero each time the falling edge of the V-SYNC is detected.

The SYNC-GSM 5 comprises the time counter 3 shown in FIG. 1. The time counter 3 measures the execution load on the respective GSM 4 (the above-mentioned time count value). The SYNC-GSM 5 also comprises a reference table as shown in FIG. 2 and an arithmetic operation unit for use in calculating the usage rate from the time count values. The reference table is used by the presentation mechanism to provide the time count values that are obtained through the measurement by the time counter 3.

With the above-mentioned components, the SYNC-GSM 5 has features of the control processor 1 and the time counter 3 shown in FIG. 1 along with its original feature of supplying the V-SYNC and draw ready signals to the internal circuit. The slave SYNC 7 comprises an averaging unit, a reference table as shown in FIG. 2, and an arithmetic operation unit. The averaging unit receives the time count values from the SYNC-GSMs 5 to obtain an average of these time count values. The reference table in the slave SYNC 7 is used for the presentation of the average of the time count values by the presentation mechanism. The arithmetic operation unit is for use in calculating the usage rate from the time count values. The average of the time count values may be used as a quantified amount of the execution loads on the slave MG 6 or on the GSB 100.

<GSM>

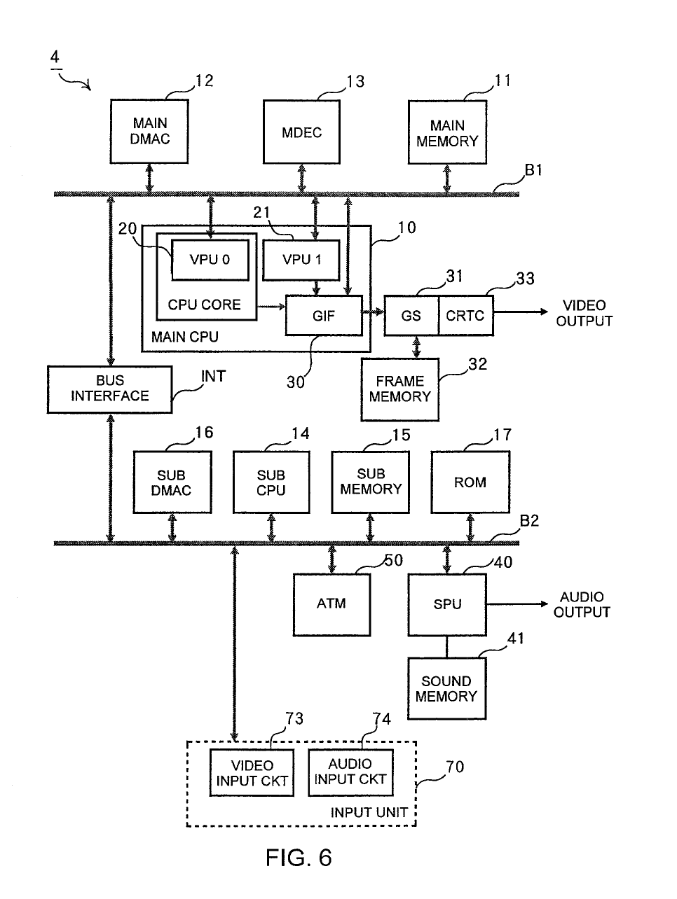

The GSM 4 operates at the timing of the V-SYNC in the SYNC-GSM 5. The GSM 4 begins image processing in response to the draw ready signal to produce a frame image corresponding to the stream of the image data. The image data forming the stream of the image data are read out of the external storage 410 connected to the master CP 400 and are subjected to a predetermined image processing into the frame image. The frame image is used to make it possible to produce images on the display device DP. After completion of the operation allocated to the local GSM 4, the GSM 4 supplies the processing result to the master MG 200 via the slave MG 6. The GSM 4 also supplies the draw complete signal to the master SYNC 300 via the SYNC-GSM 5 and the slave SYNC 7. Furthermore, the GSM 4 supplies the time count value to the slave MG 6 and the slave SYNC 7. The time count value represents the execution load on the local GSM 4 measured by the SYNC-GSM 5. As apparent from the above, the GSM 4 is at the center of the image processing in the integrated graphics processing system. Functional features of the GSM 4 according to this embodiment are shown in detail in FIG. 6.

In FIG. 6, the GSM 4 comprises a dual bus structure having a main bus B1 and a sub bus B2. The main bus B1 and the sub bus B2 are connected to each other via a bus interface INT. The bus interface INT allows communications between the main bus B1 and the sub bus B2. The main bus B1 is connected to a main central processing unit (CPU) 10, a main memory 11, a main direct memory access controller (DMAC) 12, a motion picture experts group (MPEG) decoder (MDEC) 13, a second vector processing unit (VPU1, also referred to as a “second VPU”) 21, and a graphical synthesizer interface (GIF) 30. The main CPU 10 is a single-chip semiconductor device on which a microprocessor and a first vector processing unit (VPU0, also referred to as a “first VPU”) 20 are mounted. The main memory 11 is formed of a random access memory (RAM). The GIF 30 serves as an arbiter between the first VPU 20 and the second VPU 21. The main bus B1 is also connected through the graphical synthesizer interface 30 to a graphics synthesizer (GS) 31 that serves as graphics processing means. The graphics synthesizer 31 is associated with a CRT controller (CRTC) 33 that produces video output signals.

An integrated semiconductor device may be used in view of size reduction of the system. In such a case, all or a part of the main memory 11, the main DMAC 12, the MDEC 13, the second VPU 21, the GIF 30, and the GS 31 are mounted on a single semiconductor chip. The main bus B1 connects the single-chip semiconductor device and the remaining components. The CRTC 33 sends the frame images to the slave MG 6.

When the integrated graphics processing system is turned on, the main CPU 10 loads a boot program from the ROM 17 on the sub bus B2 through the bus interface INT and starts executing the boot program to invoke the operating system. The main CPU 10 performs geometry processing, in cooperation with the first VPU 20, on three-dimensional object data. For example, the main CPU 10 performs geometry processing on coordinates of the vertices of polygons making up a 3D object. The main CPU 10 comprises a fast memory called scratch pad RAM (SPR) that can store temporarily the result of the operation cooperatively performed with the first VPU 20.

The first VPU 20 comprises a plurality of arithmetic operation units that calculate a real part of a floating point number. The arithmetic operation units calculate the floating points in parallel. More specifically, the main CPU 10 and the first VPU 20 carry out the part of the arithmetic operation that requires a complicated geometry processing for each polygon. With this arithmetic operation, the main CPU 10 and the first VPU 20 create a display list. The display list includes polygon defining information such as shading modes information and coordinates of the vertices.

The polygon defining information is formed of drawing area defining information and polygon information. The drawing area defining information is used for defining a drawing area for a graphic image to be displayed. The drawing area defining information comprises offset coordinates of frame memory addresses for the drawing area and coordinates of a drawing clipping region that limits the effect of drawing operations. When the coordinates of a polygon to be drawn fall outside the clipping region, drawing of the corresponding portion of the polygon has no effect. The polygon information comprises information about the attributes of the polygon and information about the vertices. The information about the attributes of the polygon is used to specify either one of shading, alpha-blending, texture mapping, and texture mapping operation modes. The information about the vertices represents the colors of the vertices as well as the coordinates of the polygon vertices within the drawing area and within the texture region.

The second VPU 21 is similar to the first VPU 20. The second VPU 21 comprises a plurality of arithmetic operation units that calculate a real part of a floating point number. The arithmetic operation units calculate the floating points in parallel. The second VPU 21 generates a display list containing the results of the arithmetic operations.

The first VPU 20 and the second VPU 21 are similar in configuration to each other. However, they function as independent geometry engines that take different parts in the arithmetic operation. Typically, the first VPU 20 undertakes rather complicated calculations involving, for example, motion of an object (i.e., non-routine geometry processing). The second VPU 21 undertakes calculations of an object that are simple but require a large number of polygons, such as a building on the background (i.e., routine geometry processing). The first VPU 20 carries out macroscopic operations along the video rates while the second VPU 21 is adapted to operate in synchronization with the GS 31. For this purpose, the second VPU 21 comprises a direct line connected to the GS 31. On the other hand, the first VPU 20 is in close cooperation with the microprocessor(s) in the main CPU in order to facilitate the programming of the complicated processes.

The display lists generated by the first and second VPUs 20 and 21 are transferred to the GS 31 via the GIF 30. The GIF 30 arbitrates the transfer of the display lists. In this embodiment, the GIF 30 has a function to arrange the display lists in order from highest priority to lowest and then transfer them to the GS 31 according to that priority. The information that represents the priority of the display lists is typically described in a tag thereof when the VPUs 20 and 21 generate the display lists. However, the priority may be determined independently by the GIF 30.

The GS 31 has drawing contexts stored therein. The GS 31 reads the relevant drawing context in accordance with the identification information for the graphics context contained in the display list supplied from GIF 30. The GS 31 then draws an object (polygon) into the frame memory 32 with the drawing context. This drawing process is called “rendering”. The frame memory 32 may also be used as a texture memory. This means that the pixel images on the frame memory 32 may be placed on the surface of the polygon as textures.

The main DMAC 12 controls the DMA transfer of data among the circuits connected on the main bus B1. The main DMAC 12 also controls the DMA transfer of data among the circuits on the sub bus B2 as well in accordance with the status of the bus interface INT. The MDEC 13 operates in parallel with the main CPU 10 and decodes the data compressed in the Motion Picture Experts Group (MPEG) format or the Joint Photographic Experts Group (JPEG) format.

The sub bus B2 is connected to a sub CPU 14 containing a microprocessor, a sub memory 15 formed of a random-access memory (RAM), a sub DMAC 16, a read-only memory (ROM) 17 on which programs such as the operating system are stored, a sound processing unit (SPU) 40, an ATM communication controller 50, and an input section 70. The sound processing unit 40 reads audio data out of a sound memory 41 and produces it as an audio output. The ATM communication controller 50 controls transmission of data through a network. The SYNC-GSM 5 is connected to the sub bus B2 while the slave NET 9 is connected to the ATM communication controller 50. The input section 70 comprises a video input circuit 73 and an audio input circuit 74. The video and audio input circuits 73 and 74 are used to receive image/video data and sound/audio data, respectively, from an external device.

In this embodiment, the stream of the image data is received from the slave CP 8 (branched from the master CP 400) through the video input circuit 73. The sub CPU 14 carries out the necessary operations in accordance with the programs stored in the ROM 17. The sub DMAC 16 controls the DMA transfer of data among the circuits on the sub bus B2 only when the bus interface INT separates the main bus B1 and the sub bus B2.

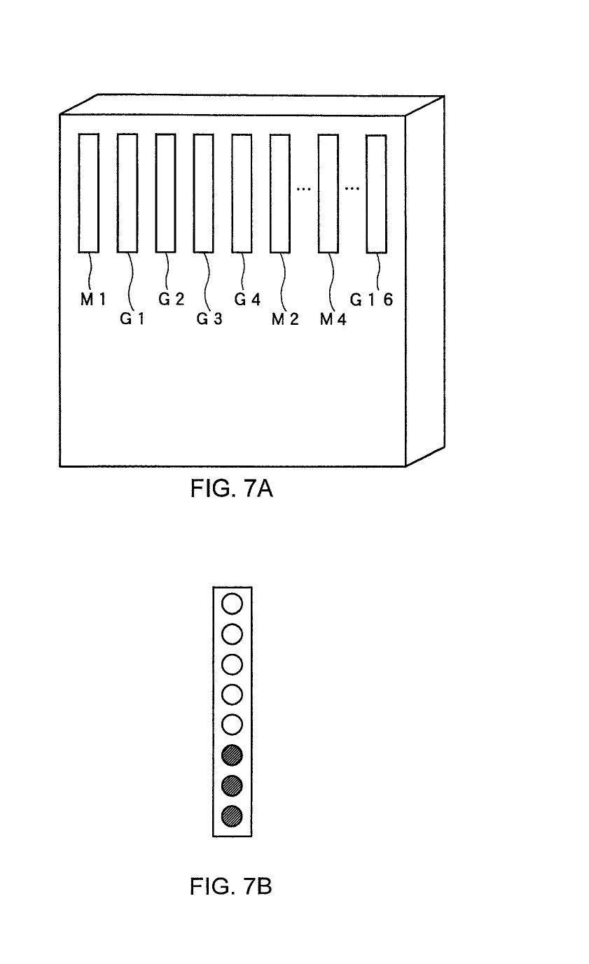

The integrated graphics processing system according to this embodiment having the above-mentioned configuration is contained in, for example, a housing as shown in FIG. 7A as a commercial product. The housing has indicators G1 to G16 and M1 to M4 provided on one surface thereof. The indicators are an example of the presentation mechanism that allows visual indication of the execution loads on the GSMs 4 and the GSBs 100. The indicators G1 to G16 are connected to the GSMs 4 while the indicators M1 to M4 are connected to the GSBs 100.

Details of the indicators G1 to G16 and M1 to M4 are shown in FIG. 7B. In this example, the indicators G1 to G16 and M1 to M4 each has eight light-emitting components such as LEDs. The number of the light-emitting components to be lit is determined based on the execution load (time count value). The indicators are configured as bar graph indicators to provide visual presentation of the execution loads. How many light-emitting components are to be lit for how much of an execution load can be determined using the reference table shown in FIG. 2. In the example shown in FIG. 7B, three light-emitting components are lit. This state corresponds to the percentage of the maximum load according to the reference table in FIG. 2. This is equivalent to 25% to 37.5% of the maximum usage rate of 100%.

The indicators G1 to G16 and M1 to M4 are not limited to the one shown in FIG. 7B. Instead, they may be achieved by using a single light-emitting component that can emit light beams of different colors. The colors of the light-emitting component may be varied depending on the execution loads.

<Practical Application>

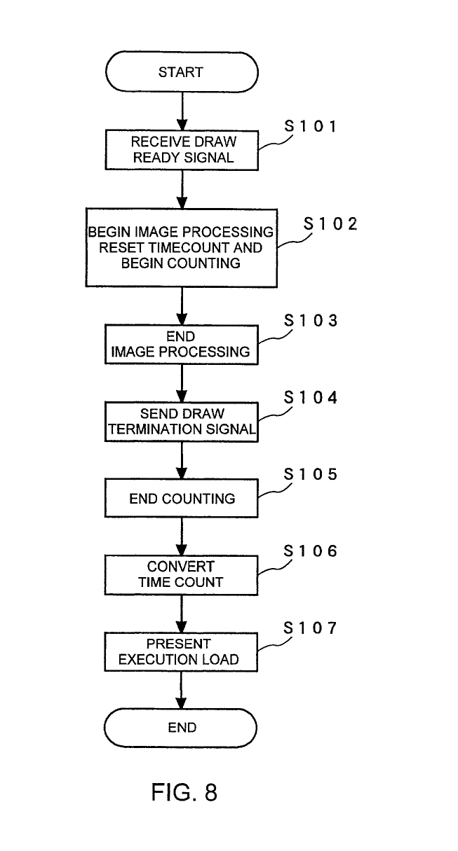

Next, how the execution loads on the GSMs 4 and the GSBs 100 can be presented is described in detail. FIG. 8 is a flow chart illustrating a routine to determine an execution load on the GSMs 4. The execution load on a single GSM 4 can be determined in the manner as described above. The parts of the GSMs 4 other than the SYNC-GSM 5 are equivalent to the graphics processor 2 in FIG. 1. The SYNC-GSM 5 corresponds to the control processor 1 and the time counter 3 in FIG. 1.

In FIG. 8, the GSM 4 receives by the SYNC-GSM 5 the V-SYNC and draw ready signals from the master SYNC 300 via the slave SYNC 7 and begins processing the stream of the image data (step S 01). The SYNC-GSM 5 resets the time count value in the time counter 3 in response to the draw ready signal and begins counting the time interval. The GSM 4 carries out processing of the stream of the image data (step S102). The GSM 4 then loads the frame image into the frame memory 32. After completion of the image processing, the GSM 4 supplies a draw termination signal to the master SYNC 300 via the SYNC-GSM 5 and the slave SYNC 7 (steps S103 and S104). The SYNC-GSM 5 terminates the counting of the time interval in response to the reception of the draw termination signal (step S105). After the counting of the time interval, the SYNC-GSM 5 calculates the above-mentioned usage rate from the time count value in the arithmetic operation unit. The SYNC-GSM 5 then determines, by using the reference table, the number of the light-emitting components to be lit based on the usage rate (step S106). The signal representing the number of the light-emitting components to be lit is supplied from the GSM 4 to the corresponding indicator. The indicators G1 to G16 activate the light-emitting component(s) according to the signal to provide the user with the information about the execution load on the GSM 4 in question (step S 107).

In the above-mentioned embodiment, the frame memory of the graphics processor 2 has a double buffer configuration. However, the GSMs 4 in the integrated graphics processing system are not necessarily required to support double buffering. A single buffer may equally be used. With the single buffer configuration, there is a waiting period between the completion of the loading of a frame image and reception of the subsequent V-SYNC signal. The type of the buffer does not affect the determination of the execution loads according to the present invention.

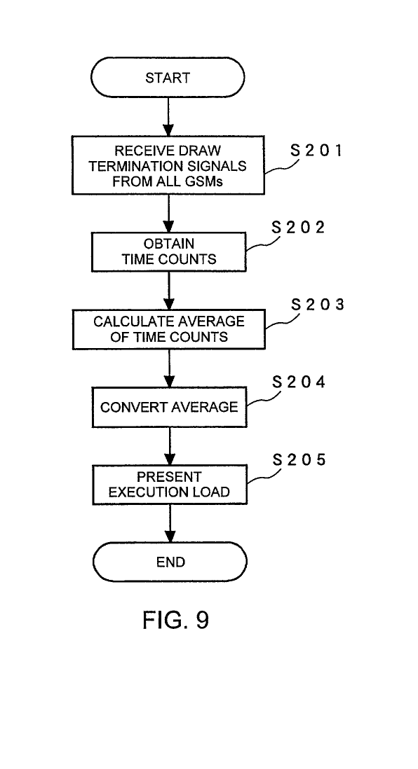

Next, how the execution loads on the GSBs 100 can be presented is described in detail with reference to FIG. 9. The slave SYNC 7 sends the V-SYNC and the draw ready signal to all GSMs in the GSB 100 where the sending slave SYNC 7 is located. The slave SYNC 7 then waits for the draw termination signals from all GSMs 4 involved. The slave SYNC 7 obtains the time count values from all GSMs 4 in response to the reception of the draw termination signals supplied from all GSMs 4 (steps S201 and S202). Simultaneous transmission of the draw termination signals rarely occurs from the GSMs 4. In this respect, the slave SYNC 7 may obtain the time count value from the corresponding GSM 4 each time when it receives the draw termination signal.

The slave SYNC 7 calculates an average of the time count values obtained from all GSMs 4 involved (step S203). The average can be obtained by means of dividing the sum of the time count values from the GSMs 4 by the number of the GSMs 4. This operation is performed by the arithmetic operation unit. The slave SYNC 7 calculates the usage rate from the calculated average and determines the number of the light-emitting components to be lit according to that average. In this event, the slave SYNC 7 uses the reference table as shown in FIG. 2 (step S204). The signal representing the number of the light-emitting components is supplied from the GSB 100 to the corresponding indicators M1 to M4. The indicators M1 to M4 activate the light-emitting components according to the signal to provide visual presentation of the execution load on the GSB 100 (step S205). The above-mentioned operation permits a real-time presentation of the execution loads on the corresponding GSMs 4 and GSBs 100 by using the indicators G1 to G16 and M1 to M4 provided on the surface of the housing as shown in FIG. 7A. Accordingly, it is easy for users of the integrated graphics processing system (such as those who create content) to know the state of the execution loads according the number of the indicators G1 to G16 and M1 to M4 which light.

A creator typically produces different contents and programs for each of the different GSMs 4. For example, one GSM 4 may be used for producing hairs of a human. A second GSM 4 may be used for producing the body of the same human. Another GSM 4 may be used for the background. Such distributed processing of the contents permits more realistic images and graphics.

The execution load on the GSM 4 varies depending on the size of the images to be handled by that GSM 4. A heavier execution load is often required for a larger volume of images to be handled. When it is expected that the execution load will be too heavy, some part of the operation may be allocated to any other GSM 4 having a much lighter load to balance the execution load among the GSMs 4.

The present embodiment makes it possible to check quickly the execution loads on the GSMs 4 and the GSBs 100 through the indicators G1 to G16 and M1 to M4. The execution loads are obtained not on the basis of assumptions, as is conventionally done, but on the basis of quantitative measurements. The user can check quantitatively how much resource is left for the GSMs 4 and the GSBs 100. Alternatively, he or she can check whether there is any GSM or GSB that is possibly overloaded. This allows easy and fast tuning of the contents and/or programs such that the execution loads are balanced among the GSMs 4.

While the above description has been made in conjunction with the case where the present invention is applied to image processing, the present invention may equally be applied to the processing of other kinds of data, including audio data. With the present invention, delicate, high quality sounds such as orchestral sounds may be produced. In such a case, the data for the production of the sounds are separately handled by the GSMs 4. In addition, video processing may be combined with sound production for more complicated processing of multimedia data. As shown in FIG. 6, the GSMs 4 of the present embodiment may be available for such processing. With sound production, the sound data obtained are used as the signals to produce sounds through a predetermined speaker. The sound comes out through the speaker in synchronization with the frame images by the slave MG 6 and the master MG 200. The sound data are supplied to the GSMs 4 through the audio input circuit 74 shown in FIG. 6 while the sound data are produced through the SPU 40.

As is apparent from the above, according to the present invention, the execution loads on the processing system can be presented to a user from the beginning to the end of the operation. This provides the user with information about the execution loads.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An information processing system, comprising:
a processor operable to carry out predetermined information processing;
a signal producing unit operable to produce an execution enabling signal for causing said processor to carry out said predetermined information processing; and
a load determination unit operable to determine an execution load associated with said predetermined information processing;
said processor being operable to begin execution of said predetermined information processing in response to receipt of said execution enabling signal and to produce an execution termination signal upon completion of said predetermined information processing, said execution termination signal representing said completion of said predetermined information processing;
said load determination unit being operable to begin determination of said execution load in response to receipt of said execution enabling signal and to terminate said determination of said execution load in response to receipt of said execution termination signal.

2. An information processing system as claimed in claim 1, further comprising a presentation unit operable to provide to a user a real-time presentation of a measurement of said execution load determined by said load determination unit.

3. An information processing system as claimed in claim 1, wherein said load determination unit clears a previous measurement of said execution load already determined in response to said receipt of said execution enabling signal and begins determination of a new measurement.

4. An information processing system as claimed in claim 1, wherein said processor operates in response to clock signals, and wherein said load determination unit determines said execution load by counting a number of said clock signals from a beginning to an end of said predetermined information processing.

5. An information processing system as claimed in claim 1, wherein said load determination unit includes a presentation unit operable to provide a presentation of a measurement of said execution load which varies in form in real time depending on said measurement of said execution load.

6. An information processing system as claimed in claim 5, wherein said presentation unit includes a plurality of light-emitting components, said presentation unit varying a number of said light-emitting components which are lit depending on said measurement of said execution load.

7. An information processing system as claimed in claim 5, wherein said presentation unit includes a light-emitting component capable of emitting light beams of different colors, said presentation unit varying the color of said light beams depending on said measurement of said execution load.

8. An information processing system, comprising:
a processor operable to execute information processing having two or more steps, said information processing being carried out one step after another step in a successive manner;
a signal producing unit operable to produce an execution enabling signal at a predetermined cycle for causing said processor to execute said information processing; and
a load determination unit operable to determine an execution load associated with said information processing for each of said steps;
said processor being operable to begin execution of said information processing for one step each time said processor receives said execution enabling signal, and being operable to produce an execution termination signal upon completion of said information processing for said one step, said execution termination signal representing said completion of said information processing for said one step;
said load determination unit being operable to begin determination of said execution load in response to receipt of said execution enabling signal and to terminate said determination in response to receipt of said execution termination signal.

9. An information processing system as claimed in claim 8, further comprising a presentation unit operable to provide a real-time presentation of a measurement of said execution load determined by said load determination unit.

10. An information processing system as claimed in claim 8, wherein said load determination unit clears a previous measurement of said execution load already determined in response to said receipt of said execution enabling signal and begins determination of a new measurement.

11. An information processing system, comprising:
a processor operable to carry out predetermined information processing;
a signal producing unit operable to produce an execution enabling signal for causing said processor to carry out said predetermined information processing; and
a load determination unit operable to determine an execution load associated with said predetermined information processing;
said processor being operable to supply a first enable signal and a second enable signal selectively to said load determination unit in response to receipt of said execution enabling signal, said first enable signal enabling execution of said predetermined information processing and representing an active state of execution when said predetermined information processing is being carried out, said second enable signal representing an inactive state of execution when said predetermined information processing is not being carried out;
said load determination unit being operable to begin determination of said execution load when said load determination unit receives said first enable signal and to terminate said determination when said load determination unit receives said second enable signal.

12. An information processing system as claimed in claim 11, wherein said load determination unit produces a value representing said execution load when said first enable signal is changed to said second enable signal.

13. An information processing system as claimed in claim 11, wherein said load determination unit clears a previous measurement of said execution load already determined and begins said determination when said second enable signal is changed to said first enable signal.

14. An integrated information processing system, comprising:
a plurality of information processing systems; and
a presentation unit;
each of said information processing systems including:
a processor operable to carry out predetermined information processing;
a signal producing unit operable to produce an execution enabling signal for causing said processor to carry out said predetermined information processing;
a load determination unit operable to determine an execution load associated with said predetermined information processing;
said processor being operable to begin execution of said predetermined information processing in response to receipt of said execution enabling signal and to produce an execution termination signal upon completion of said predetermined information processing, said execution termination signal representing said completion of said predetermined information processing;
said load determination unit being operable to begin determination of said execution load in response to receipt of said execution enabling signal and to terminate said determination of said execution load in response to receipt of said execution termination signal; and
said presentation unit being operable to provide to a user a real-time presentation of a measurement of said execution load in each of said information processing systems.

15. An integrated information processing system as claimed in claim 14, wherein said plurality of information processing systems are housed in a housing, said presentation unit being arranged on a front surface of said housing in a corresponding relationship with said processor of each of said information processing systems.

16. A method for determining an execution load associated with predetermined information processing, comprising:
producing an execution enabling signal for carrying out the predetermined information processing;
beginning the predetermined information processing in response to receipt of the execution enabling signal;
beginning determination of the execution load in response to receipt of the execution enabling signal;
producing an execution termination signal upon completion of the predetermined information processing, the execution termination signal representing the completion of the predetermined information processing; and
terminating the determination of the execution load in response to receipt of the execution termination signal.

17. A method for determining an execution load associated with information processing having two or more steps, the information processing being carried out one step after another step in a successive manner, comprising:
producing an execution enabling signal at a predetermined cycle for causing the information processing to be carried out step by step;
beginning execution of the information processing for one step each time the execution enabling signal is received;
producing an execution termination signal upon completion of the information processing, the execution termination signal representing the completion of the information processing;
beginning determination of the execution load each time the execution enabling signal is received; and
terminating the determination in response to receipt of the execution termination signal.

18. A computer-readable recording medium recorded with a program for determining an execution load associated with predetermined information processing, said computer program comprising:
producing an execution enabling signal for carrying out the predetermined information processing;
beginning the predetermined information processing in response to receipt of the execution enabling signal;
beginning determination of the execution load in response to receipt of the execution enabling signal;
producing an execution termination signal upon completion of the predetermined information processing, the execution termination signal representing the completion of the predetermined information processing; and
terminating the determination of the execution load in response to receipt of the execution termination signal.
